(19) United States
(12) Patent Application Publication
(10) Pub. No.: US 2019/0150424 A1
(43) Pub. Date: May 23, 2019

(54) RETROFIT FOR FARM EQUIPMENT

(71) Applicant: Steve N.G. SIMON, Rodney (CA)

(72) Inventor: Steve N.G. SIMON, Rodney (CA)

(21) Appl. No.: 16/313,189

(22) PCT Filed: Jun. 27, 2017
(86) PCT No.: PCT/CA2017/050780

§ 371 Date: Dec. 26, 2018

Related U.S. Application Data
(60) Provisional application No. 62/355,080, filed on Jun. 27, 2016.

(51) Int. Cl. A01M 7/00

(52) U.S. Cl. CPC A01M 7/0053; A01B 39/12

(57) ABSTRACT

Systems and methods relating to the replacement of specific parts in farm equipment to thereby adjust the farm equipment's capabilities. To modify the ground clearance of farm equipment, especially sprayers with a strut type suspension, the spindles of the suspension system along with the air spring absorber are replaced. The original spindles are replaced with longer spindles while the air spring absorber is replaced with one that allows for an increased range of travel. As well, the fixed linkage arms that connect the air height control valves to the suspension system are also replaced with longer arms. These longer linkage arms may be of a fixed length or they may be of an adjustable length.

### TECHNICAL FIELD

The present invention relates to farm equipment. More specifically, the present invention relates to the retrofitting of farm equipment to result in more useful equipment.

### BACKGROUND

Advances in farming equipment have increased their efficiency, productivity, and have lowered their prices. Such advances have allowed farmers to accomplish more with the various forms of farm machinery. However, farm machinery built for one type of crop may not be suitable for other types of crops. As an example, one type of crop may require farm machinery to have a certain minimum ground clearance while other types of crops may require a different ground clearance.

The above is true for, among other types of farm machinery, sprayers. Some types of crops require sprayers to be above the resulting crops while others need to have the sprayers closer to the ground. Unfortunately, most farm equipment, including sprayers, do not have configurable ground clearances. This deficiency has led to farmers needing to purchase different farm equipment for different crops, with a corresponding increase in the costs of planting different crops.

There is therefore a need for systems, methods, or devices that will allow for a retrofit of existing farm equipment to allow such equipment to be used for different crops of different heights.

### SUMMARY

The present invention provides systems and methods relating to the replacement of specific parts in farm equipment to thereby adjust the farm equipment's capabilities. To modify the ground clearance of farm equipment, especially sprayers with a strut type suspension, the spindles of the suspension system along with the air spring absorber are replaced. The original spindles are replaced with longer spindles while the air spring absorber is replaced with one that allows for an increased range of travel. As well, the fixed linkage arms that connect the air height control valves to the suspension system are also replaced with longer arms. These longer linkage arms may be of a fixed length or they may be of an adjustable length.

In a first aspect, the present invention provides a kit for retrofitting farm equipment, the kit comprising:
at least one pair of replacement spindles for replacing spindles installed on said farm equipment, said spindles being for use on a strut-type suspension system for said farm equipment;
at least one replacement spring mechanism for replacing original spring mechanisms on said strut-type suspension system, said at least one replacement spring mechanism allowing for more travel by said strut-type suspensions than said original spring mechanisms;

wherein
said at least one pair of replacement spindles are longer than said spindles installed on said farm equipment;
after said kit has been installed on said farm equipment, said farm equipment has a higher ground clearance.

In a second aspect, the present invention provides a method for retrofitting farm equipment, the method comprising:
locating at least one original spindle installed on said farm equipment, said at least one original spindle being installed on a strut-type suspension system of said farm equipment;
removing said at least one original spindle;
replacing said at least one original spindle with at least one replacement spindle, said at least one replacement spindle being longer than said at least one original spindle;
locating at least one original spring mechanism installed on said farm equipment;
replacing said at least one original spring mechanism with at least one replacement spring mechanism, said at least one replacement spring mechanism allowing more travel of said strut-type suspension system than said at least one original spring mechanism.

### BRIEF DESCRIPTION OF THE DRAWINGS

The embodiments of the present invention will now be described by reference to the following figures, in which identical reference numerals in different figures indicate identical elements and in which:

FIG. 1 is an exploded view of a strut-type suspension system for farm equipment; and

FIG. 2 is an exploded view of an automatic air hose assembly for farm equipment.

### DETAILED DESCRIPTION

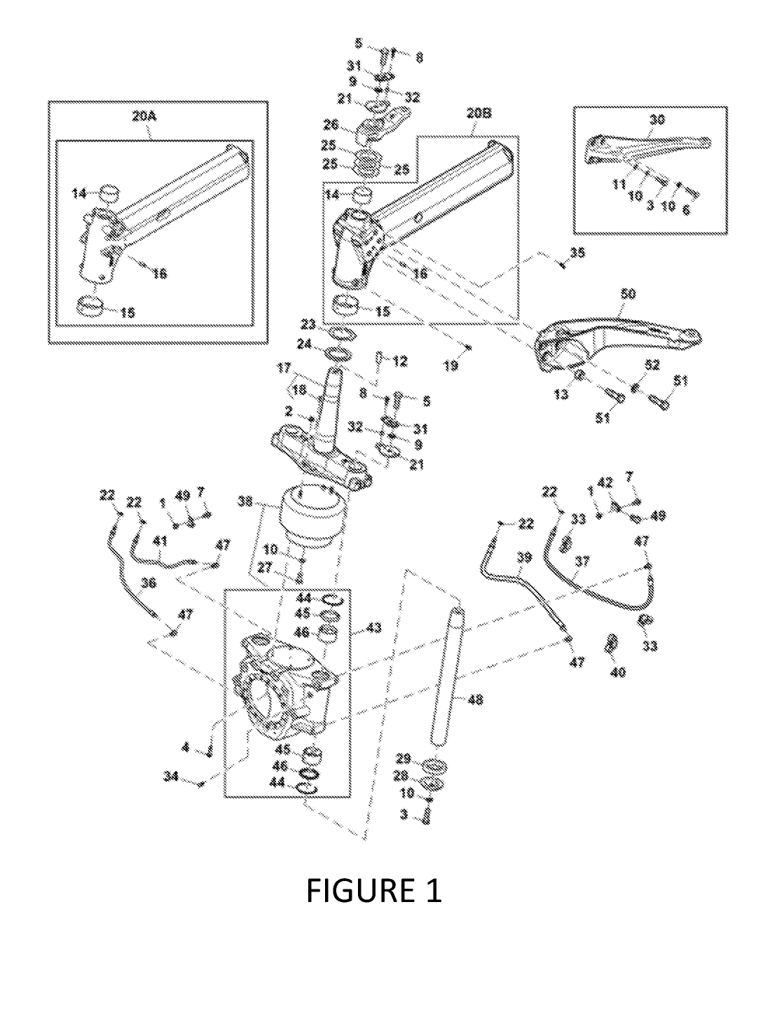

Referring to FIG. 1, an exploded view of a right hand side strut suspension system for a self-propelled sprayer is illustrated. As can be seen, a spindle 48 is illustrated. However, a matching spindle is not illustrated but is also present in the system. To adjust the clearance height of the self-propelled sprayer, both original spindles are to be replaced with longer spindles. The length of the replacement spindles, and thus the final adjusted height of the sprayer, may be controlled by a travel limiting device such as a spacer, bumper, or stop on or near the replacement spindle. Since the replacement spindle would be one component that controls the distance allowed for the suspension system to move up and down, a suitable device that limits the travel of the suspension system, such as a spacer or a bumper, can be used to limit how far this distance is.

Also to be replaced is the original air spring 38.

This air spring 38, also known as an absorber or a spring mechanism, is to be replaced with an air spring or absorber that allows for greater or further travel than the original air spring. As with the spindles, a travel limiting device, such as a suitable bumper or spacer or stop, can also be used to control how far the suspension system travels or moves up and down. Installing a suitable spacer or bumper can limit the amount of travel that the suspension system can undergo.

It should be clear that FIG. 1 illustrates only one strut suspension assembly. A corresponding left hand side suspension assembly would also need to have its spindles replaced along with the corresponding absorber.

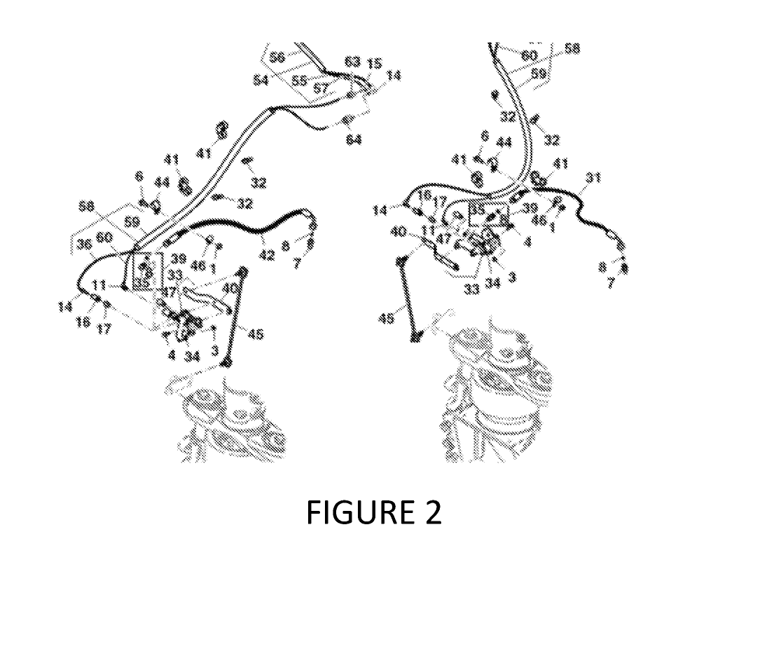

In addition to the above components, the original linkage arms that link the automatic air height control valve assembly to the air spring in the suspension system must also be replaced with longer linkage arms. Referring to FIG. 2, an exploded view of the automatic air height control valve assembly is illustrated. The original linkage arms 45 in the figure are clearly illustrated and these would need to be replaced. It should be noted that current designs of sprayers use fixed length linkage arms. However, these linkage arms can be replaced with other fixed length linkage arms or adjustable linkage arms. As well, adjustable replacement linkage arms can be mechanical, pneumatic, or electrical type linkage arms. Depending on the configuration, these adjustable replacement linkage arms may be extended or shortened from within the driver's cab of the sprayer. Similarly, the adjustable replacement linkage arms may be adjusted from outside the driver's cab. In one implementation, each linkage arm was replaced by a linear actuator. Depending on the implementation and the configuration of the linkage arms, custom brackets may need to be used to attach the replacement linkage arm to the points where the original linkage arms were attached. As noted previously, linear actuators may be used as replacement linkage arms. Using linear actuators would allow for better control of the length of the replacement linkage arm.

To retrofit a single self-propelled sprayer, each corner or wheel or strut type suspension of the sprayer would need to have its original linkage arm, spindles, and absorber replaced. As, each wheel would need two replacement spindles, one replacement linkage arm, and one replacement absorber. A single sprayer would thus need eight replacement spindles, four replacement linkage arms, and four replacement absorbers.

Of course, the replacement spindles, air spring/absorbers, and linkage arms will need to be at least as sturdy as the original parts.

In another embodiment of the invention, the components needed to replace the relevant parts noted above can be assembled as a kit with a suitable set of instructions. Accordingly, such a kit would have eight replacement spindles, four replacement air springs, and four replacement linkage arms.

It should also be noted that while the above description and the accompanying figures applies to self-propelled sprayers, other farm equipment may also be retrofitted or adjusted in a similar manner. Any farm equipment that uses a strut type suspension system can have its ground clearance adjusted by locating the spindles that control the distance that the suspension system travels as well as the “shock absorbers” or spring mechanisms that also control the distance that the suspension system travels, and replacing these components. The spindles would be replaced by longer spindles while the spring mechanisms would be replaced by similar spring mechanisms that allow a greater travel distance. Other components that would be affected by the greater travel of the suspension systems would, of course, also need to be replaced to take into account this greater travel distance. One such component affected by the greater travel would be the linkage arm noted above.

Regarding implementation, experiments have shown that John Deere self-propelled sprayers models R4030, R4038, and R4045 are suitable for use with the invention. For these models of sprayers, the spindle (John Deere part number KK26139), the air spring or absorber (John Deere part number AKK12461), and the linkage arm (John Deere part number AN403729) would need to be replaced.

A person understanding this invention may now conceive of alternative structures and embodiments or variations of the above all of which are intended to fall within the scope of the invention as defined in the claims that follow.

We claim:

1. A kit for retrofitting farm equipment, the kit comprising:
at least one pair of replacement spindles for replacing spindles installed on said farm equipment, said spindles being for use on a strut-type suspension system for said farm equipment;
at least one replacement spring mechanism for replacing original spring mechanisms on said strut-type suspension system, said at least one replacement spring mechanism allowing for more travel by said strut-type suspensions than said original spring mechanisms;
wherein
said at least one pair of replacement spindles are longer than said spindles installed on said farm equipment;
after said kit has been installed on said farm equipment, said farm equipment has a higher ground clearance.

2. The kit according to claim 1, further comprising at least one replacement linkage arm for replacing at least one original linkage arm installed on said farm equipment.

3. The kit according to claim 1, further including at least one travel limiting device for limiting a range of movement of said strut-type suspension system.

4. The kit according to claim 3, wherein said at least one travel limiting device comprises at least one of: bumpers, stops, and spacers.

5. The kit according to claim 1, wherein said farm equipment is a sprayer.

6. The kit according to claim 1, wherein said farm equipment is a self-propelled sprayer.

7. A method for retrofitting farm equipment, the method comprising:
locating at least one original spindle installed on said farm equipment, said at least one original spindle being installed on a strut-type suspension system of said farm equipment;
removing said at least one original spindle;
replacing said at least one original spindle with at least one replacement spindle, said at least one replacement spindle being longer than said at least one original spindle;
locating at least one original spring mechanism installed on said farm equipment;
replacing said at least one original spring mechanism with at least one replacement spring mechanism, said at least one replacement spring mechanism allowing more travel of said strut-type suspension system than said at least one original spring mechanism.

8. The method according to claim 7, further including:
locating at least one original linkage arm installed on said farm equipment;
replacing said at least one original linkage arm with at least one replacement linkage arm, said at least one replacement arm being longer than said at least one original linkage arm.
